(19) United States
(12) Patent Application Publication
(10) Pub. No.: US 2026/0233640 A1
(43) Pub. Date: Aug. 13, 2026

(54) USE OF ROAD PREVIEW TO DYNAMICALLY ADJUST A SEAT FEATURE FOR OCCUPANT COMFORT DURING CORNERING

(71) Applicant: GM Global Technology Operations LLC, Detroit, MI (US)

(72) Inventors: Ryan Aaron Gellner, Livonia, MI (US); Tyler P. Morris, Madison Heights, MI (US); Brian K. Saylor, South Lyon, MI (US); Eric B. Hoyer, White Lake, MI (US); Anderson De Lima, Rochester, MI (US); Xin Jin, Troy, MI (US); Jason M. Kolk, White Lake, MI (US)

(21) Appl. No.: 19/050,186

(22) Filed: Feb. 11, 2025

(51) Int. Cl. B60N 2/02

(52) U.S. Cl. CPC B60N 2/026; B60N 2/0273; B60N 2/0274

(57) ABSTRACT

A vehicle includes a system for controlling a seat of the vehicle. An actuator controls a firmness of the seat. A processor is configured to determine a curvature of a road section being traversed by the vehicle, determine a longitudinal velocity of the vehicle over the road section, determine a mass of an occupant of the vehicle, wherein the occupant is seated in the seat of the vehicle, calculate a force on the occupant as the vehicle traverses the road section based on the curvature of the road section, the longitudinal velocity of the vehicle and the mass of the occupant, and activate the actuator to control the firmness of the seat to balance the force on the occupant as the vehicle traverses the road section.

The subject disclosure relates to vehicles, and in particular to a seat of a vehicle that stabilizes an occupant within the seat against high lateral forces when the vehicle is in a turn.

A performance vehicle is designed to have heightened capabilities in acceleration, cornering, braking, speed, etc. When cornering or taking a curve, the performance vehicle can experience high lateral forces. These forces are generally transferred to an occupant, passenger or driver, causing the occupant to slide within his or her seat. In order to maintain control of the vehicle, it is desired that the occupant, particularly a driver, does not slide within his or her seat. Accordingly, it is desirable to provide an apparatus and method for countering or balancing the lateral forces on an occupant during a curve.

### SUMMARY

In one exemplary embodiment, a method of controlling a seat of a vehicle is disclosed. A curvature of a road section being traversed by the vehicle is determined. A longitudinal velocity of the vehicle over the road section is determined. A mass of an occupant of the vehicle is determined, wherein the occupant is seated in the seat of the vehicle. A force on the occupant as the vehicle traverses the road section is calculated based on the curvature of the road section, the longitudinal velocity of the vehicle and the mass of the occupant. The firmness of the seat is controlled to balance the force on the occupant as the vehicle traverses the road section.

In addition to one or more of the features described herein, the method further includes calculating a moment on the occupant as the vehicle traverses the road section based on the force and a moment arm of the occupant and controlling the firmness of the seat to balance the moment on the occupant as the vehicle traverses the road section.

In addition to one or more of the features described herein, the method further includes estimating the moment arm for the occupant from an image of the occupant and calculating the moment using the moment arm.

In addition to one or more of the features described herein, controlling the firmness of the seat further includes determining a bolster which receives the force of the occupant and balancing the force by controlling at least one of a firmness of the bolster and an angle of the bolster.

In addition to one or more of the features described herein, the method further includes modeling the occupant using a human body model of the occupant.

In addition to one or more of the features described herein, the method further includes performing a calculation on the human body model to at least one of minimize an occupant drift, minimize muscle forces of the occupant, minimize pressure points on the occupant, and maximize a comfort score of the occupant.

In addition to one or more of the features described herein, the method further includes estimating the force on the occupant using data from at least one of, a tire pressure sensor, a fuel level sensor, a wiper sensor, a thermometer, and a radius of curvature of the road section.

In another exemplary embodiment, a system for controlling a seat of a vehicle is disclosed. The system includes an actuator and a processor. The actuator controls a firmness of the seat. The processor is configured to determine a curvature of a road section being traversed by the vehicle, determine a longitudinal velocity of the vehicle over the road section, determine a mass of an occupant of the vehicle, wherein the occupant is seated in the seat of the vehicle, calculate a force on the occupant as the vehicle traverses the road section based on the curvature of the road section, the longitudinal velocity of the vehicle and the mass of the occupant, and activate the actuator to control the firmness of the seat to balance the force on the occupant as the vehicle traverses the road section.

In addition to one or more of the features described herein, the processor is further configured to calculate a moment on the occupant as the vehicle traverses the road section based on the force and a moment arm of the occupant and control the firmness of the seat to balance the moment on the occupant as the vehicle traverses the road section.

In addition to one or more of the features described herein, the processor is further configured to estimate the moment arm for the occupant from an image of the occupant and calculating the moment using the moment arm.

In addition to one or more of the features described herein, the processor is further configured to control the firmness of the seat by determining a bolster which receives the force of the occupant and balancing the force by controlling at least one of a firmness of the bolster and an angle of the bolster.

In addition to one or more of the features described herein, the processor is further configured to control the firmness of the seat using a lookup table including results of a simulation of the occupant using a human body model of the occupant.

In addition to one or more of the features described herein, the lookup table includes data for at least one of minimizing an occupant drift, minimizing muscle forces of the occupant, minimizing pressure points on the occupant, and maximizing a comfort score of the occupant.

In addition to one or more of the features described herein, the processor is further configured to estimate the force on the occupant using data from at least one of a tire pressure sensor, a fuel level sensor, a wiper sensor, and a thermometer.

In yet another exemplary embodiment, a vehicle is disclosed. The vehicle includes a seat, an actuator that controls a firmness of the seat, and a processor. The processor is configured to determine a curvature of a road section being traversed by the vehicle, determine a longitudinal velocity of the vehicle over the road section, determine a mass of an occupant of the vehicle, wherein the occupant is seated in the seat of the vehicle, calculate a force on the occupant as the vehicle traverses the road section based on the curvature of the road section, the longitudinal velocity of the vehicle and the mass of the occupant, and activate the actuator to control the firmness of the seat to balance the force on the occupant as the vehicle traverses the road section.

In addition to one or more of the features described herein, the processor is further configured to calculate a moment on the occupant as the vehicle traverses the road section based on the force and a moment arm of the occupant and control the firmness of the seat to balance the moment on the occupant as the vehicle traverses the road section.

In addition to one or more of the features described herein, the processor is further configured to estimate the moment arm for the occupant from an image of the occupant and calculating the moment using the moment arm.

In addition to one or more of the features described herein, the processor is further configured to control the firmness of the seat by determining a bolster which receives the force of the occupant and balancing the force by controlling at least one of a firmness of the bolster and an angle of the bolster.

In addition to one or more of the features described herein, the processor is further configured to control the firmness of the seat using a lookup table including results of a simulation of the occupant using a human body model of the occupant.

In addition to one or more of the features described herein, the lookup table includes data for at least one of minimizing an occupant drift, minimizing muscle forces of the occupant, minimizing pressure points on the occupant, and maximizing a comfort score of the occupant.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in a side view, in accordance with an exemplary embodiment;

FIG. 2 shows a perspective view of a seat of the vehicle, in an illustrative embodiment;

FIG. 3 shows the seat with an impression indicating a distribution of mass and weight on the seat by the occupant during a right turn;

FIG. 4 shows an image of a road section ahead of the vehicle that is ahead of the vehicle;

FIG. 5 is a diagram illustrating a method for calculating lateral acceleration or centripetal acceleration on the occupant;

FIG. 6 is a flowchart illustrating details of a method for force balancing at seat bolsters;

FIG. 7 shows a head on view of the seat in an illustrative embodiment; and

FIG. 8 shows a view of the seat of FIG. 7 with a model of an occupant in the seat, for illustrative purposes.

### DETAILED DESCRIPTION

The following description is merely exemplary in nature and is not intended to limit the present disclosure, its application or uses. It should be understood that throughout the drawings, corresponding reference numerals indicate like or corresponding parts and features.

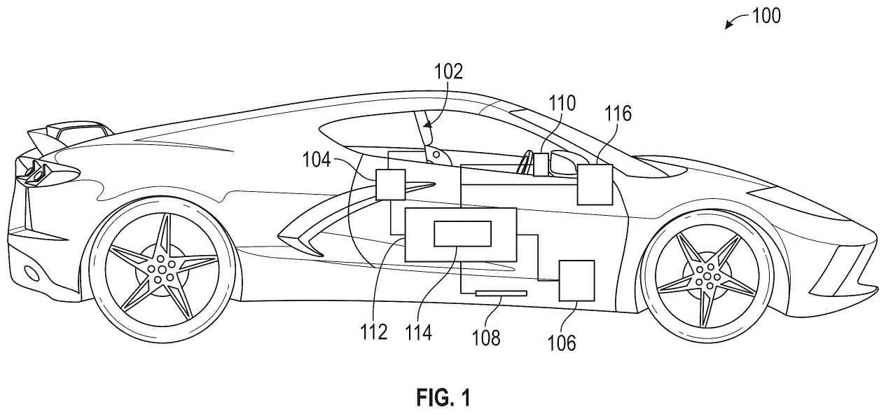

In accordance with an exemplary embodiment, FIG. 1 shows a vehicle 100 in a side view. The vehicle 100 can be any type of vehicle. In an illustrative embodiment, the vehicle 100 is a performance vehicle or any vehicle in which a curve or a turn can be taken at high speeds, such that high lateral forces are created on an occupant. The vehicle 100 includes a seat 102 in which an occupant, a passenger, or a driver is seated. An actuator system 104 is in communication with the seat 102. The actuator system 104 includes at least one actuator for controlling the seat or a configuration of the seat, as discussed herein.

The vehicle 100 includes a vehicle sensor system 106 that tracks dynamic parameters of the vehicle, including a speedometer for tracking a speed of the vehicle, a steering wheel sensor that tracks a steering wheel angle and/or a steering wheel rate, a digital camera, a GPS tracking system, etc. A pressure mat 108 can be used to measure a parameter of the occupant, such as a mass of the occupant. An internal camera 110 can be used to obtain an image of the occupant as he sits in the seat 102.

Data from the vehicle sensor system 106, the pressure mat 108 and/or the internal camera 110 can be provided to a controller 112 having a processor 114. The controller 112 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 112 may also include a non-transitory computer-readable medium that stores instructions which are processed by one or more processors of the controller to implement processes detailed herein.

The controller 112 determines lateral forces and/or moments on the occupant, determines methods for balancing or countering the lateral forces and/or moments to stabilize the occupant in his seat and/or to maximize a comfort of the occupant, and controls the actuator system 104 to place the seat 102 in a configuration suitable for balancing or countering the lateral forces and/or momentum.

An auxiliary sensor system 116 includes auxiliary sensors that can provide additional data to the controller 112 usable in calculations of lateral forces and/or moments. The auxiliary sensor system 116 can include, for example, a tire pressure sensor, a fuel level sensor, a wiper sensor or rain sensor, and a thermometer. A wiper sensor or rain sensor can indicate wet road conditions, for example, and therefore the effect of rain on lateral forces. Similarly, a thermometer can also be indicative of a presence or absence of ice on the road, which can affect lateral forces.

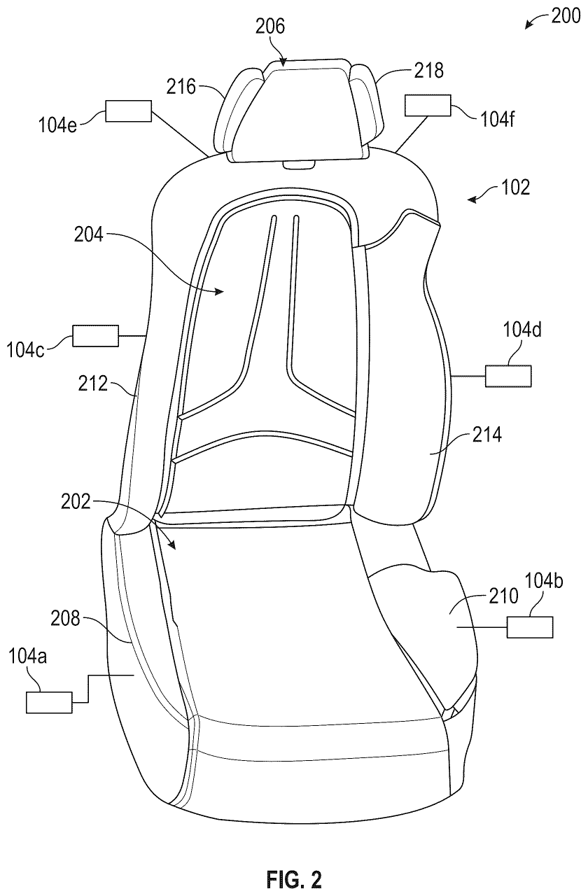

FIG. 2 shows a perspective view 200 of the seat 102 of the vehicle 100, in an illustrative embodiment. The seat 102 includes a seat bottom 202, a back rest 204 and a head rest 206. The seat includes a plurality of bolsters that contain the occupant within the seat and which can be adjusted based on lateral forces on the occupant. A right seat bolster 208 is located to a right side of the seat bottom 202 (from the point of view of an occupant in the seat). A left seat bolster 210 is located to a left side of the seat bottom 202. A right lumbar bolster 212 is located to a right side of the back rest 204 and a left lumbar bolster 214 is located to a left side of the back rest. A right head bolster 216 is located to a right side of the head rest 206 and a left head bolster 218 is located to a left side of the head rest 206. Although six bolsters are shown for illustrative purposes, this is not meant to be a limitation of the seat. The seat can include additional bolsters that can be used to counter lateral forces on the occupant using the methods disclosed herein.

Each bolster has an associated actuator that controls a firmness of the bolster. Right seat bolster 208 and left seat bolster 210 are controlled respectively by right seat actuator 104a and left seat actuator 104b. Right lumbar bolster 212 and left lumbar bolster 214 are controlled, respectively, by right lumbar actuator 104c and left lumbar actuator 104d. Right head bolster 216 and left head bolster 218 are controlled, respectively by right head actuator 104e and left head actuator 104f. Each actuator can be controlled individually by a signal from the controller 112, FIG. 1.

In various embodiments, an actuator controls a firmness of its associated bolster. The actuator can also control a bolster angle for the bolster. In some embodiments, the actuator can control both bolster firmness and bolster angle. Various actuator types can be used. For purposes of illustration, the bolster is described herein as a having a balloon or bellows and the actuator is described herein as a pump that introduces air into the bellows to inflate the bolster and increase the firmness of the bolster and that releases air from the bellows to deflate the bolster and decrease the firmness of the bolster. In another embodiment, the associated bolster can be adjusted by mechanically moving the bolster toward the center of the seat or away from the center of the seat. Such adjustment can be made by adjusting the bolster angle. For such a bolster, the actuator can be a mechanical actuator such as an electric motor. Other methods for changing a firmness and/or angle of the bolster can also be used, in other embodiments.

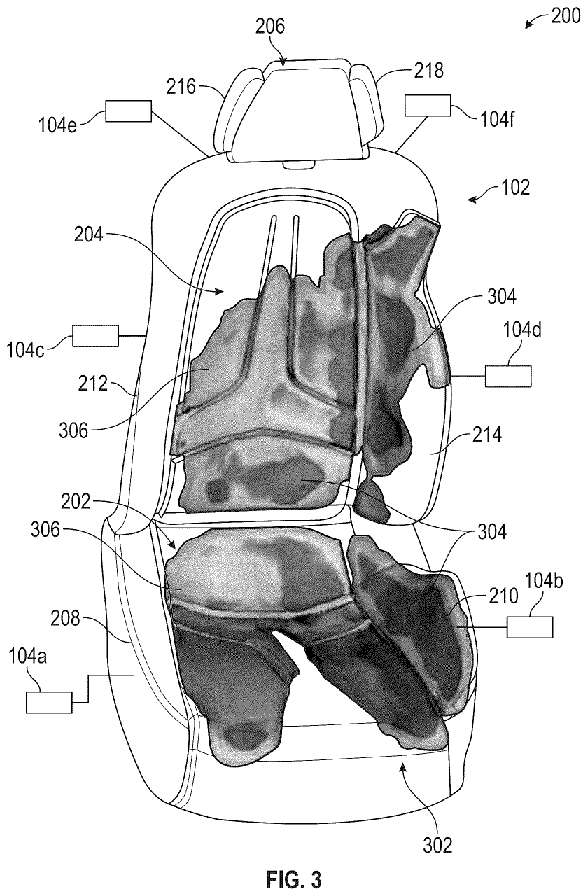

FIG. 3 shows the seat 102 with an impression 302 indicating a distribution of mass and weight on the seat by the occupant during a right turn. The impression 302 shows regions of high weight distribution 304 and of low weight distribution 306. The impression 302 shows that the high weight distribution 304 regions are located primarily at the left seat bolster 210 and the left lumbar bolster 214 during the right turn.

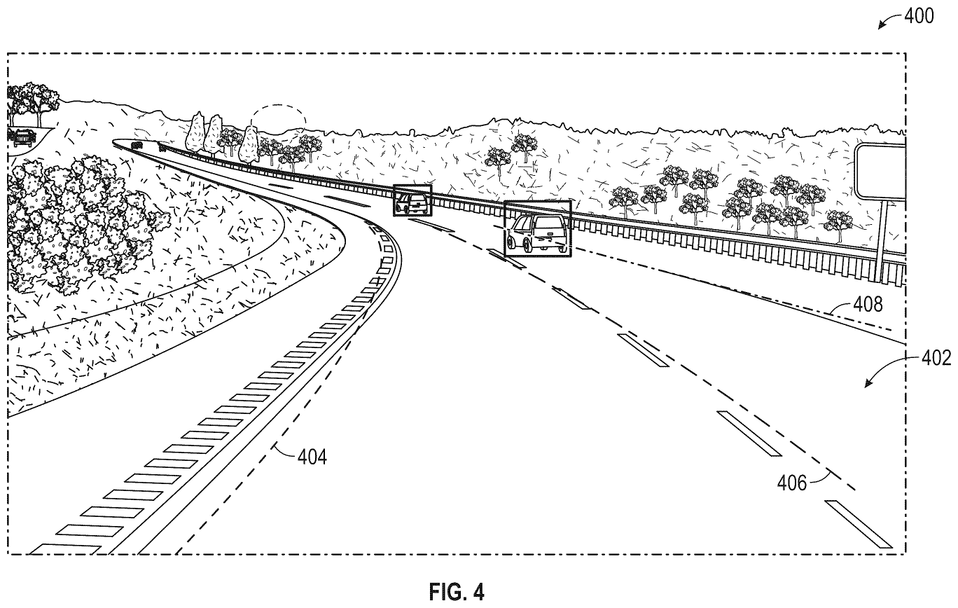

FIG. 4 shows an image 400 of a road section 402 that is ahead of the vehicle 100. The image 400 is obtained from an externally facing digital camera (a component of the vehicle sensor system 106) disposed on the vehicle 100. Various radii of curvature 404, 406, 408 are shown superimposed on the road section 402. Alternatively, or in addition, the curvature can be determined from GPS sensors, map data, etc. The controller 112 performs analysis of the image 400 to compute a radius of curvature of the road section 402. The radius of curvature can be used to calculate a centripetal acceleration on the vehicle and/or the occupant.

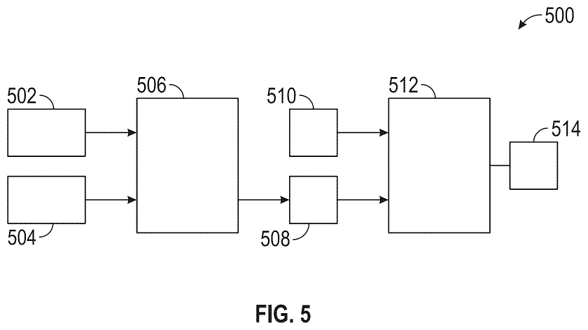

FIG. 5 is a diagram 500 illustrating a method for calculating lateral acceleration or centripetal acceleration forces on the occupant. The lateral acceleration is a result of a longitudinal velocity v of the vehicle through a radius of curvature r of the road section being traversed by the vehicle. The lateral acceleration a_{c} can be calculated using a known equation, as shown in Eq. (1):

$${a}_{c} = \frac{{v}^{2}}{r} \qquad Eq . ( 1 )$$

A front camera 502 and/or a GPS sensor 504 can provide data to a turn radius calculator 506. The turn radius calculator 506 outputs the radius of curvature 508 (r). The radius of curvature 508 (r) and the longitudinal velocity 510 (v) of the vehicle are provided to an acceleration calculator 512, which outputs the lateral acceleration 514 (a_{c}).

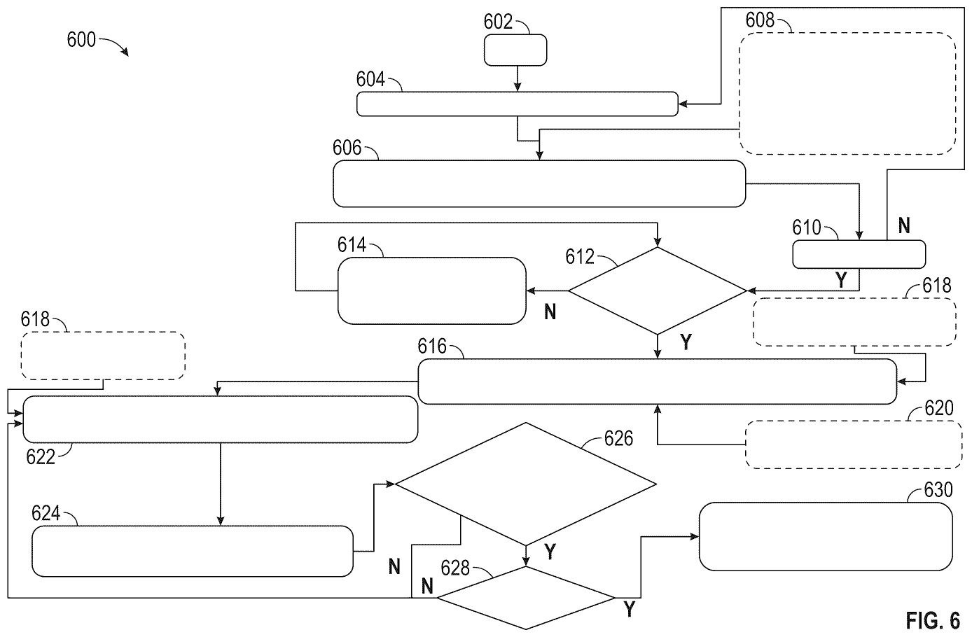

FIG. 6 is a flowchart 600 illustrating details of a method for force balancing at seat bolsters. The method starts at box 602. In box 604, the road ahead of the vehicle is monitored for any upcoming curvature. In box 606, an expected moment on the vehicle can be calculated based on lateral acceleration using the longitudinal velocity and the curvature of the upcoming road section. The calculation in box 606 can be affected by various parameters provided by the auxiliary sensor system 116 (e.g., tire pressure sensor, fuel level sensor, wiper sensor, thermometer, etc.). These parameters are provided to the box 606 from box 608.

In box 610, the radius of curvature of the upcoming section is compared to a threshold radius. An exemplar of a threshold radius is 950 meters. If the radius of curvature is greater than or equal to the threshold radius (i.e., a minor turn), the method returns to box 604 for more monitoring of the road. If, in box 610, the radius of curvature is less than the threshold radius (i.e., a sharp turn), the method proceeds to box 612.

In box 612, the steering wheel angle (SWA) is compared to a steering wheel angle threshold (SWA threshold). For illustrative purposes, the SWA threshold is 3 degrees. If the steering wheel angle is less than or equal to the SWA threshold (i.e., insignificant change in steering wheel angle), the method proceeds to box 614. In box 614, the steering wheel angle is continuously monitored, looping back to box 612. If, in box 612, the steering wheel angle exceeds the SWA threshold (i.e., significant steering into the turn), the method proceeds to box 616.

In box 616, a command is issued to increase a bladder pressure in a bolster that is towards an outside of the curve for an occupied seat. The command can be based on the occupant mass, which can be provided from box 618. The command can also be adjusted based on a user preference, which is provided from box 620. From box 616, the method proceeds to box 622. Table 1 shows a table of illustrative bladder pressures for different ranges of acceleration of the vehicle.

TABLE 1

| | Moment normalized by | Bladder |
|---|---|---|
| \|a_{c}\|(m/s\hat{ }2) | mass (N · m/kg) | pressure (psi) |
| 0 < \|a_{c}\| < 3 | 1.8 | 1.5 |
| 3 ≤ \|a_{c}\| < 6 | 3.5 | 2.0 |
| 6 ≤ \|a_{c}\| | 7.1 | 3.0 |

Boxes 622, 624, 626 and 628 perform an iterative procedure to perform pressure balancing at the seat. In box 622, the occupant's moment is calculated and a suitable bladder pressure is applied at a bladder for a relevant bolster. This calculation uses the data of box 618 (occupant's mass). In box 624, the upcoming roadway curvature and the steering angle and steering wheel rate are constantly monitored and the lateral force and occupant's moment are thus continuously updated. From box 624, the method proceeds to box 626. In box 626, the steering wheel is compared to the SWA threshold. If the steering wheel is greater than or equal to the SWA threshold, the method returns to box 622 where the bladder pressure is updated based on calculated performed in box 624. Otherwise, the method proceeds to box 628. In box 628, the radius of curvature is compared to a radius threshold. If the radius of curvature is less than or equal to the radius threshold, the method returns to box 622, where the bladder pressure is updated based on calculated performed in box 624. Otherwise, the method proceeds to box 630. In box 630, a command is issued to return the pressure at the bladder to a default or nominal pressure, thereby returning the bolster to its original state (i.e., the state for the vehicle moving in a straight line). The bolster thus returns to its original state based on at least one of a radius of curvature and a steering wheel angle. The method ends in box 630.

Lateral forces and moments on the occupant can be calculated using various methods. In one embodiment, a human model can be created of the occupant, and the model can be used to obtain an objective function suitable for minimizing a parameter for the occupant. The occupant can be modelled using the human body model offline and simulations can be performed offline in advance. Results of the simulation can be stored in a lookup table. The controller 112 can choose a suitable bolster adjustment using the lookup table.

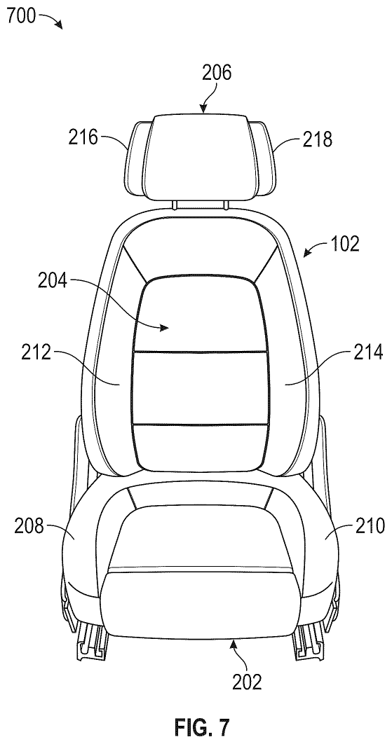

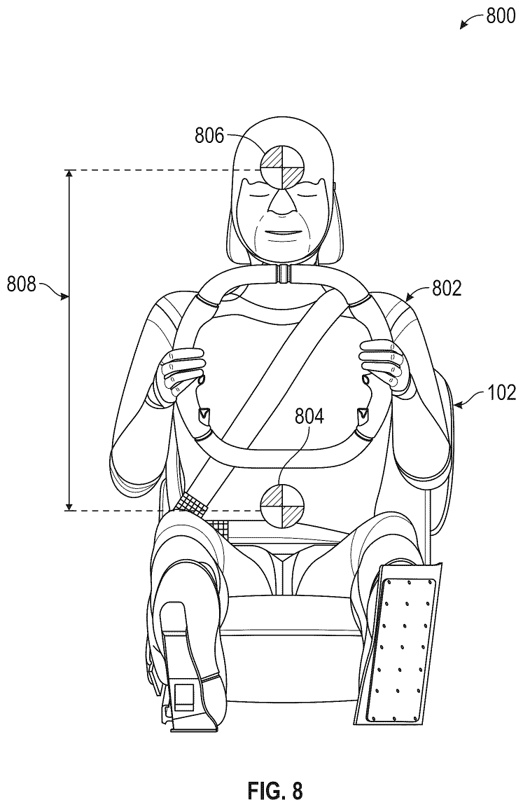

FIG. 7 shows a head on view 700 of the seat 102 in an illustrative embodiment. FIG. 8 shows a view 800 of the seat 102 of FIG. 7 with a model 802 of an occupant in the seat, for illustrative purposes. The model 802 can be used to calculate forces and moments on an occupant. The model can have various parameters, such as mass, (as well as mass of different body parts, including a mass of the head) center of gravity of the body (body CG 804), center of gravity of the head (head CG 806) and a moment arm 808 for the body of the occupant (measured from the body CG to the head CG).

In one embodiment, the model 802 can be used for calculations that minimize forces and moments on the occupant. In other embodiment, the model can be used for calculations that minimize an occupant drift (i.e., a drift of the occupant within the seat, which is observed using internal cameras or calculated using physical equations), minimize muscle forces (which is simulated by the human body model), minimize pressure points (which is simulated using a pressure map of the human model), or maximize a comfort score of the occupant (which is determined by experiment).

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of controlling a seat of a vehicle, comprising:
determining a curvature of a road section being traversed by the vehicle;
determining a longitudinal velocity of the vehicle over the road section;
determining a mass of an occupant of the vehicle, wherein the occupant is seated in the seat of the vehicle;
calculating a force on the occupant as the vehicle traverses the road section based on the curvature of the road section, the longitudinal velocity of the vehicle and the mass of the occupant; and
controlling the firmness of the seat to balance the force on the occupant as the vehicle traverses the road section.

2. The method of claim 1, further comprising calculating a moment on the occupant as the vehicle traverses the road section based on the force and a moment arm of the occupant and controlling the firmness of the seat to balance the moment on the occupant as the vehicle traverses the road section.

3. The method of claim 2, further comprising estimating the moment arm for the occupant from an image of the occupant and calculating the moment using the moment arm.

4. The method of claim 1, wherein controlling the firmness of the seat further comprises determining a bolster which receives the force of the occupant and balancing the force by controlling at least one of: (i) a firmness of the bolster; and (ii) an angle of the bolster.

5. The method of claim 1, further comprising modeling the occupant using a human body model of the occupant.

6. The method of claim 5, further comprising performing a calculation on the human body model to at least one of: (i) minimize an occupant drift; (ii) minimize muscle forces of the occupant; (iii) minimize pressure points on the occupant; and (iv) maximize a comfort score of the occupant.

7. The method of claim 1, further comprising estimating the force on the occupant using data from at least one of: (i) a tire pressure sensor; (ii) a fuel level sensor; (iii) a wiper sensor; (iv) a thermometer; and (v) a radius of curvature of the road section.

8. A system for controlling a seat of a vehicle, comprising:
an actuator that controls a firmness of the seat; and
a processor configured to:
determine a curvature of a road section being traversed by the vehicle;
determine a longitudinal velocity of the vehicle over the road section;
determine a mass of an occupant of the vehicle, wherein the occupant is seated in the seat of the vehicle;
calculate a force on the occupant as the vehicle traverses the road section based on the curvature of the road section, the longitudinal velocity of the vehicle and the mass of the occupant; and
activate the actuator to control the firmness of the seat to balance the force on the occupant as the vehicle traverses the road section.

9. The system of claim 8, wherein the processor is further configured to calculate a moment on the occupant as the vehicle traverses the road section based on the force and a moment arm of the occupant and control the firmness of the seat to balance the moment on the occupant as the vehicle traverses the road section.

10. The system of claim 9, wherein the processor is further configured to estimate the moment arm for the occupant from an image of the occupant and calculating the moment using the moment arm.

11. The system of claim 8, wherein the processor is further configured to control the firmness of the seat by determining a bolster which receives the force of the occupant and balancing the force by controlling at least one of: (i) a firmness of the bolster; and (ii) an angle of the bolster.

12. The system of claim 8, wherein the processor is further configured to control the firmness of the seat using a lookup table including results of a simulation of the occupant using a human body model of the occupant.

13. The system of claim 12, wherein the lookup table includes data for at least one of: (i) minimizing an occupant drift; (ii) minimizing muscle forces of the occupant; (iii) minimizing pressure points on the occupant; and (iv) maximizing a comfort score of the occupant.

14. The system of claim 8, wherein the processor is further configured to estimate the force on the occupant using data from at least one of: (i) a tire pressure sensor; (ii) a fuel level sensor; (iii) a wiper sensor; and (iv) a thermometer.

15. A vehicle, comprising:
a seat;
an actuator that controls a firmness of the seat; and
a processor configured to:
determine a curvature of a road section being traversed by the vehicle;
determine a longitudinal velocity of the vehicle over the road section;
determine a mass of an occupant of the vehicle, wherein the occupant is seated in the seat of the vehicle;
calculate a force on the occupant as the vehicle traverses the road section based on the curvature of the road section, the longitudinal velocity of the vehicle and the mass of the occupant; and
activate the actuator to control the firmness of the seat to balance the force on the occupant as the vehicle traverses the road section.

16. The vehicle of claim 15, wherein the processor is further configured to calculate a moment on the occupant as the vehicle traverses the road section based on the force and a moment arm of the occupant and control the firmness of the seat to balance the moment on the occupant as the vehicle traverses the road section.

17. The vehicle of claim 16, wherein the processor is further configured to estimate the moment arm for the occupant from an image of the occupant and calculating the moment using the moment arm.

18. The vehicle of claim 15, wherein the processor is further configured to control the firmness of the seat by determining a bolster which receives the force of the occupant and balancing the force by controlling at least one of: (i) a firmness of the bolster; and (ii) an angle of the bolster.

19. The vehicle of claim 15, wherein the processor is further configured to control the firmness of the seat using a lookup table including results of a simulation of the occupant using a human body model of the occupant.

20. The vehicle of claim 19, wherein the lookup table includes data for at least one of: (i) minimizing an occupant drift; (ii) minimizing muscle forces of the occupant; (iii) minimizing pressure points on the occupant; and (iv) maximizing a comfort score of the occupant.
